(19) United States
(12) Patent Application Publication
(10) Pub. No.: US 2009/0069973 A1
(43) Pub. Date: Mar. 12, 2009

(54) WARNING METHOD AND DEVICE FOR DEVIATION OF A MOVING VEHICLE

(76) Inventor: Shih-Hsiung LI, Taipei (TW)

Correspondence Address: PATENTTM.US, P. O. BOX 82788, PORTLAND, OR, 97282-0788, US

(21) Appl. No.: 11/853,000

(22) Filed: Sep. 10, 2007

(51) Int. Cl. G01M 17/00; G08G 1/16

(52) U.S. Cl. 701/33; 340/937; 701/301

(57) ABSTRACT

A warning method for deviation of a moving vehicle and the device of the same uses a video camera to continuously capture road images behind the vehicle and generates a video signal. A graphics processor analyzes a static background of the road based on the video signal, analyzes whether the vehicle deviates from its original path, and decides whether any moving object approaches the vehicle. In any abnormal circumstance, the graphics processor outputs a signal to a microprocessor. The microprocessor then drives an alarm to set off a warning signal to notify the driver.

### BACKGROUND OF THE INVENTION

1. Field of the Invention

The invention relates to a warning method and device and, in particular to a warning method and device for deviation of a moving vehicle from its original path.

2. Description of Related Art

As vehicles become popular, there are more traffic accidents on the streets. In most cases, they are because the distance between two adjacent vehicles is too close or the vehicle speeds are too fast and one of them suddenly shifts lanes or deviates from its original path. If a vehicle changes lanes and the vehicle behind it does not avoid or changes lanes or speed up, it is very likely for them to have a traffic accident.

Although there are lines on the road to define lanes and the traveling direction of cars and there are speed limits to reduce the possibility of traffic accidents, such measures are still insufficient in city streets with a large car flux. In such an environment with a high vehicle density and complicated situations, it is highly desirable to provide a more efficient detecting and warning method to prevent accidents.

### SUMMARY OF THE INVENTION

In view of the fact that currently there is no active warning device that helps vehicle driver monitor the driving condition and sends out warning signals in advance, it is an objective of the invention to provide a warning method for deviation of a moving vehicle to actively warn the driver when the vehicle abnormally deviates from its original path.

To achieve the above objective, the warning method includes the following steps:

continuously capturing images of the road behind the vehicle;

analyzing a static background of the road using the captured continuous images, wherein the static background includes lane-dividing lines on the road surface;

determining whether the vehicle has deviated from its original path from the relative position of the vehicle with respect to the lane-dividing lines;

outputting a warning signal when the vehicle deviates from its original path.

Another objective of the invention is to provide a warning device for deviation of a vehicle. The warning device determines whether the vehicle suddenly deviates from its original path and determines whether there is any other moving vehicle approaching. To achieve the above objective, the warning device includes at least one video camera, at least one graphics processor, a microprocessor and an alarm.

The at least one video camera is mounted at an appropriate position of the vehicle to continuously capture road images behind the vehicle and generate image signals.

The at least one graphics processor is connected to the video camera to receive image signals from the video camera and use the received image signals to analyze the static background on the road, to determine whether the vehicle deviates from its original path and determine moving objects surrounding it.

The microprocessor is connected to the graphics processor and determines whether to send out a warning to the driver.

The alarm is connected to the microprocessor and controlled by the microprocessor to send out the warning.

### BRIEF DESCRIPTION OF THE DRAWINGS

FIG. 1 is a schematic view of image projection in a video camera;

FIG. 2 is another schematic view of image projection in a video camera;

FIG. 3 is a circuit block diagram of the invention;

FIG. 4 is a planar view of the disclosed video camera installed on a vehicle;

FIG. 5 is a flowchart of the disclosed method;

FIGS. 6A to 6E are schematic views of restoring the static background from consecutive images using different sampling schemes according to the invention;

FIG. 7 is a schematic view of the road;

FIG. 8 is a schematic view showing how the invention determines whether the vehicle has any deviation from its original path;

FIG. 9 is another schematic view showing how the invention determines whether the vehicle has any deviation from its original path;

FIGS. 10A to 10D is a schematic view showing how the invention determines whether any moving object is approaching; and

FIG. 11 is a schematic view showing how the invention determines whether there is any other vehicle suddenly approaching.

### DETAILED DESCRIPTION OF THE PREFERRED EMBODIMENT

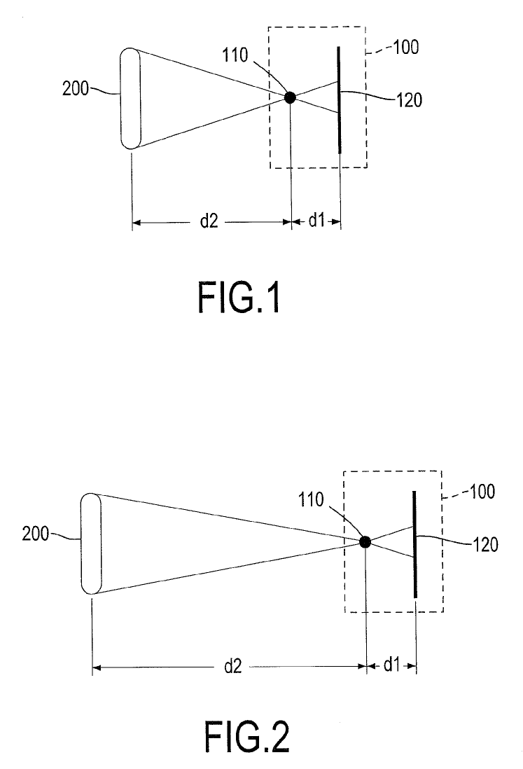

With reference to FIGS. 1 and 2, how an object 200 forms an image on a video camera such as a charge coupled device (CCD) 100 is shown. The video camera 100 includes a lens 110 and an imaging board 120 composed of multiple light sensitive diodes. Since light propagates in a straight line, with a fixed distance d1 between the lens 110 and the imaging board 120, the size of the image of an object 200 on the imaging board 120 is determined by the distance d2 between the object 200 and the lens 110. The closer the object 200 is to the lens 110 (i.e. smaller d2), the larger the projection of the object 200 is on the imaging board 120. On the other hand, the farther the object 200 is from the lens 110, the smaller the projection of the object 200 is on the imaging board 120.

The invention utilizes the above-mentioned principle to determine the relative position of a vehicle 300 on the road. According to the relative position, the invention analyzes whether the vehicle 300 deviates from its original path and whether any other vehicle or object suddenly shows up around it.

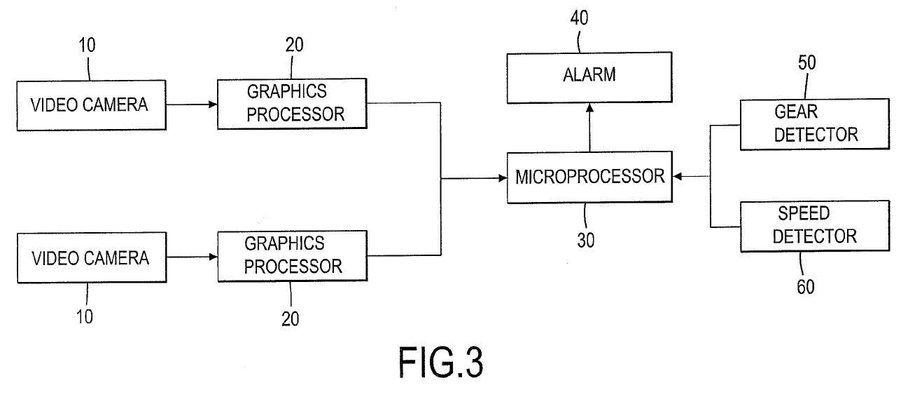

With reference to FIG. 3, the warning device of the present invention comprises at least one video camera 10, at least one graphics processor 20, a microprocessor 30, an alarm 40, an optional gear detector 50 and an optional speed detector 60.

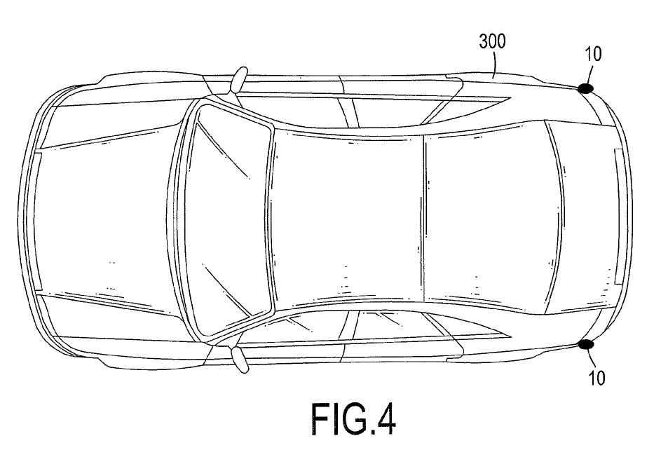

The video camera 10 is mounted at an appropriate rear position on the vehicle 300 to capture images of the surrounding environment. The video camera 10 can have a wide-angle lens in order to cover a large field. In this embodiment, there are two video cameras 10. As shown in FIG. 4, the two video cameras 10 are installed on both sides of rear positions of the vehicle for capturing images in the back. The captured images are converted into image signals.

The graphics processor 20 can be a high speed digital signal processor (DSP) and is connected to the video camera 10. To increase the processing speed of analyzing images, the two video cameras 10 are connected respectively to a graphics processor 20 in this embodiment. The invention can use a single graphics processor 20 as well in order to save the cost. The graphics processors 200 receive image signals from the video cameras 10 to analyze the static background on the road, to analyze whether the vehicle 300 suddenly deviates from its original path, to define the sizes of surrounding vehicles, and to determine whether the profile sizes of the surrounding vehicles suddenly become larger or exceed a certain limit, thereby determining whether any other vehicle is approaching the vehicle 300.

The microprocessor 30 is connected to the graphics processor 20. The determination result of the graphics processor 20 is used to determine whether a warning signal should be sent out to the driver.

The alarm 40 is connected to the microprocessor 30 and controlled by the microprocessor 30 to send a voice or light signal to notify the driver.

The gear detector 50 is connected to the microprocessor 30 to detect gear information of the vehicle 300. The gear information is sent to the microprocessor 30 in real time. In the neutral gear (N gear) or the parking gear (P gear), the microprocessor 30 turns off the graphics processor 20 and the video cameras 10. Only when the vehicle 300 is moving are the graphics processor 20 and the video cameras 10 turned on. If the vehicle 300 itself can provide the gear information, no gear detector 30 is required.

The speed detector 60 is used to obtain a current speed of the vehicle 300 to generate a speed signal. The speed signal is output to the microprocessor 30. When the vehicle stops, the car speed is zero. In this case, the microprocessor 30 turns off the graphics processor 30 and the video camera 10.

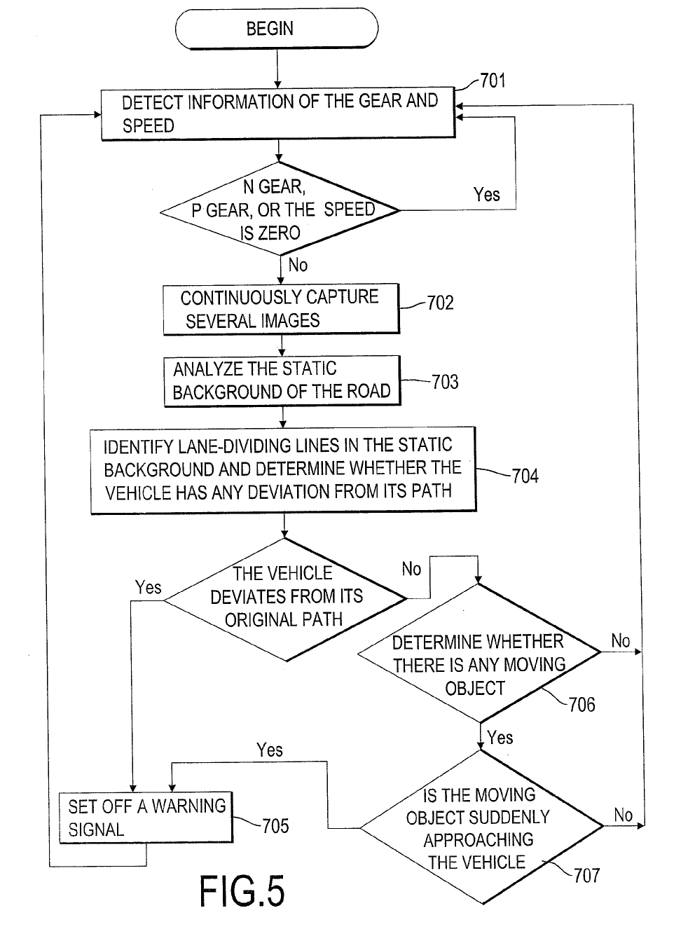

With reference to FIG. 5, the method of deviation detection and alarm includes the following steps.

Step 701 detects the gear and speed. The gear detector 50 and the speed detector 60 detect the current gear and speed of the vehicle 300. Whether the vehicle is in the N gear or P gear and whether the vehicle speed is zero can be determined.

Step 702 captures continuous images. If the vehicle is not in the N or P gear or the vehicle speed is not zero, the microprocessor 30 starts the video camera 10 and the graphics processor 20 to continuously capture images behind the vehicle and analyzes them.

Step 703 analyzes a static background. The graphics processor 20 extracts several images from the image signals from the video camera 10 to obtain a static background of the road, such as lane-dividing lines, safety island, and trees.

Step 704 determines whether the vehicle deviates from its original path. The graphics processor 20 compares the lane-dividing lines in the static background to determine whether the vehicle 300 deviates from its original path.

Step 705 sends out a warning signal. When the vehicle 300 is detected to have some deviation, the graphics processor 20 sends a signal to the microprocessor 30. The microprocessor 30 in turn drives the alarm 40 to send out a warning.

In addition to the above-mentioned steps, the invention can include the function of determining whether some other vehicle or object suddenly appears around the vehicle 300. The function works as follows.

In step 706, the graphics processor 20 determines whether there is any moving object on the road from the continuous images captured by the graphics processor 20.

In step 707, after detecting a moving object the graphics processor 20 further monitors whether the moving object suddenly approaches the vehicle 300. The monitoring method is done by analyzing the size of the moving object appearing on the screen. If the object suddenly approaches the vehicle, a warning is set off (step 705).

Regarding the method of analyzing and obtaining the static background, the graphics processor 20 uses the statistical means to achieve it. Within a very short time period, the road information captured by the video camera 10 does not differ too much. That is, there is certain continuity between consecutive images. Therefore, in several consecutive images extracted from the video signal, the road background should not change much. Since the vehicle is moving on the road, its position changes with time. By eliminating the varying parts in those images, the static background is restored.

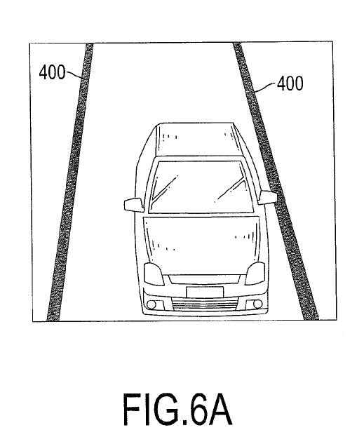

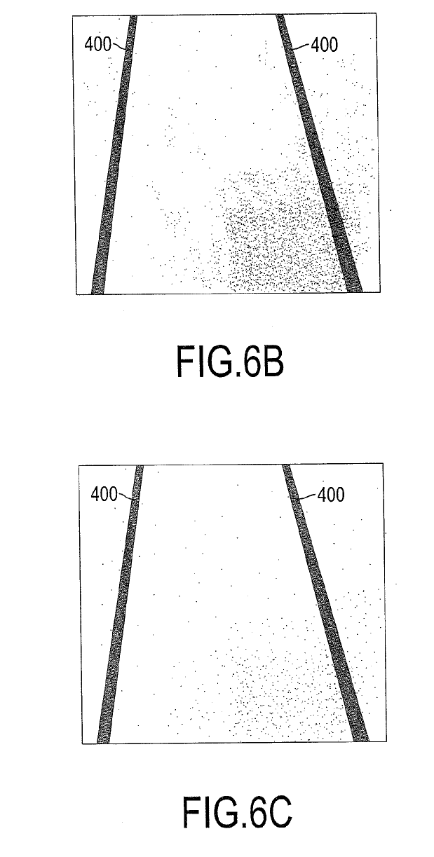

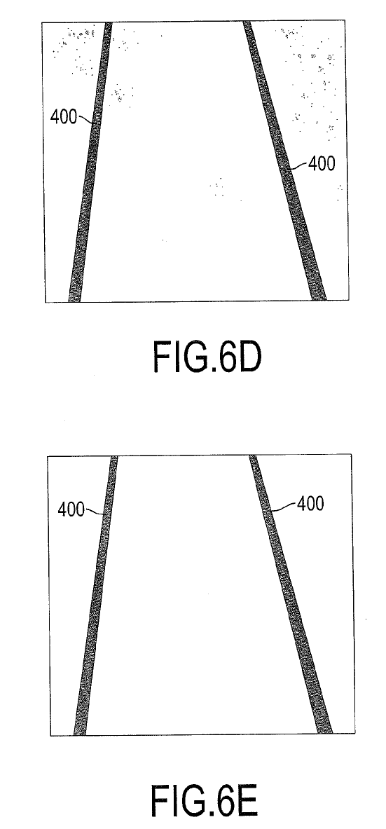

Please refer to FIGS. 6A to 6E. FIG. 6A is the original image captured by the video camera 10. FIG. 6B is the background image obtained from continuously captured 20 pictures by eliminating the varying parts. FIG. 6C is the background image obtained from continuously captured 30 pictures by eliminating the varying parts. FIG. 6D is the background image obtained from continuously captured 60 pictures by eliminating the varying parts. FIG. 6E is the background image obtained from continuously captured 100 pictures by eliminating the varying parts. Obviously, FIG. 6E has successfully restored the required static background.

Since the sampling interval is very short (e.g., 25-40 pictures per second), it takes only 1.5 to 2 seconds to capture 60 pictures if the one uses continuous 60 pictures to restore the background. Suppose the vehicle is moving at the speed of 60 km/h, the maximal displacement of the vehicle is 33 m. The distance between adjacent vehicles is not too close when they are moving at the speed of 60 km/h. Therefore, it is very unlikely for the background to have a huge change. On the other hand, the captured road images contain some regular patterns that can be used to stabilize the extracted background. The graphics processor 20 can make certain predictions on the background based upon the captured images. The predicted image and the actually captured image in the next frame are then compared. Using this method, the required number of images for restoring the background can be reduced. This can further reduce the influence of the environmental changes on the background restoration.

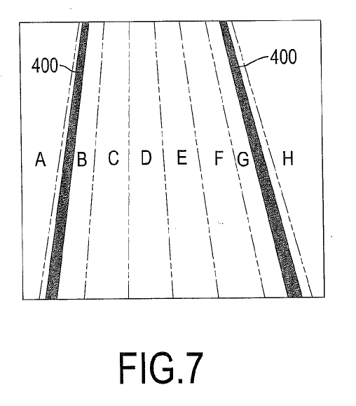

As shown in FIG. 7, each lane usually has white or yellow lane-dividing lines 400 on both sides. Vehicles are usually moving in the central portion of the lanes (instead of toward either side). The positions of the lane-dividing lines 400 captured by the video camera 10 are basically unchanged. Suppose the vehicle deviates from its original path, the relative distances between the vehicle 300 and the lane-dividing lines 400 change.

As the colors of the lane-dividing lines and the ground are significantly different, the images captured by the video camera 10 have different gray levels. For example, the ground color has a gray level of about 165, whereas the lane-dividing line has a gray level of about 228. Therefore, the graphics processor 20 can readily identify the lane-dividing lines according to the gray levels.

The method of determining whether the vehicle deviates from its original path (step 704) is as follows. After identifying the lane-dividing lines, the graphics processor 100 computes the distances between the lane-dividing lines and the vehicle. To compute the distances, the graphics processor 100 first divides the image captured by the video camera 10 into several different regions. For the illustration purpose, FIG. 7 shows that the image has eight regions, from region A to region H. In practice, the graphics processor 100 divides the image into finer regions. Since the focal distance of the video camera 10 is fixed, the distance between each region on the imaging board and the lens can be measured and stored when the device is fabricated. Once the lane-dividing lines are identified, the relative distance between the vehicle 300 and a lane-dividing line can be figured out by determining which region the lane-dividing line falls into.

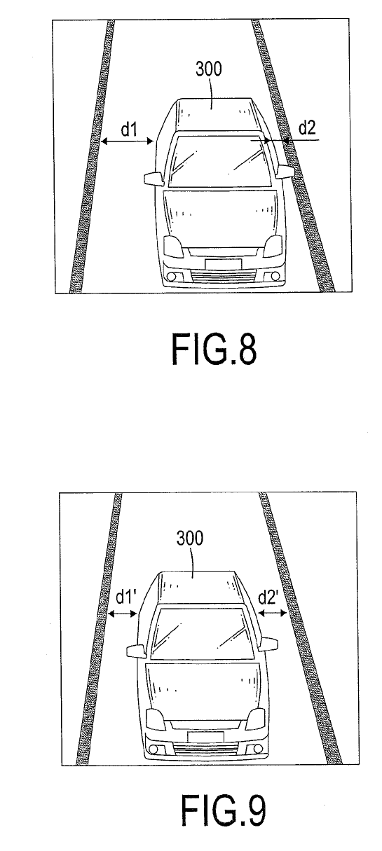

Please refer to FIGS. 8 and 9. Suppose at time T1 the distances between the vehicle 300 and the left and right lane-dividing lines are d1 and d2, respectively. At time T2, the distances between the vehicle 300 and the left and right lane-dividing lines are d1′ and d2′, respectively. As time changes from T1 to T2, if d1′<d1 and d2′>d2, the vehicle 300 is deviating to the left. On the other hand, if d1′>d1 and d2′<d2, the vehicle is deviating to the right. If the vehicle 300 is deviating to either side, the alarm 40 is driven to notify the driver. The alarm 40 can be designed so that the frequency of the warning sound gets higher as the deviation of the vehicle 300 becomes larger.

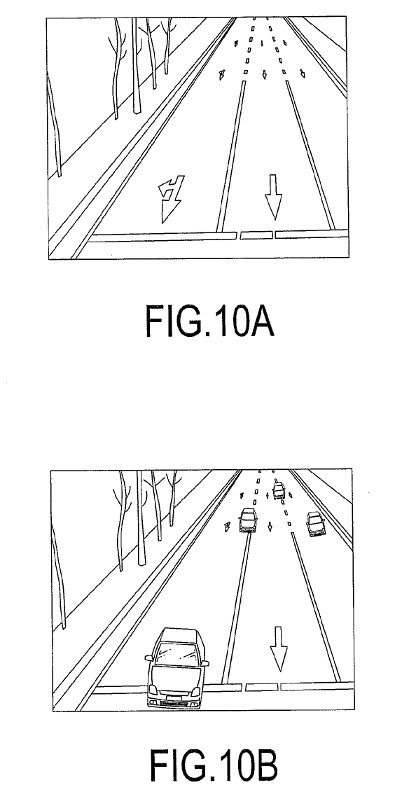

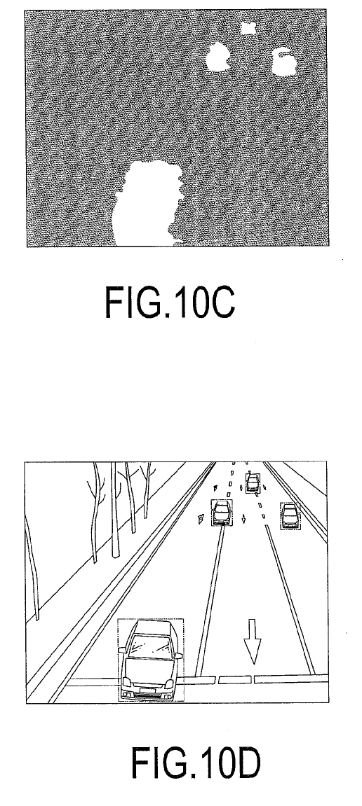

Please refer to FIGS. 10A to 10D. In step 706 of determining whether there is any moving object, the graphics processor 20 identifies the profile of surrounding vehicles based upon the following principle. If the position of the video camera 10 is unchanged, the background images taken within a short period remain the same whereas moving objects change. Therefore, it is possible to obtain the motion of a moving object by taking the difference between consecutive images. The positioning process of a vehicle is shown in FIGS. 10A to 10D. In FIG. 10A, the graphics processor 20 uses statistical means to restore the static background without any vehicle. FIG. 10B is the actual image captured by the video camera 10 when there are moving vehicles. FIG. 10C is obtained by comparing FIG. 10A and FIG. 10B, wherein the white parts are the moving objects. By eliminating parts that do not have the features of vehicles in FIG. 10C, the profiles, sizes (indicated by the dashed rectangles), and positions of other moving vehicles are identified and shown in FIG. 10D.

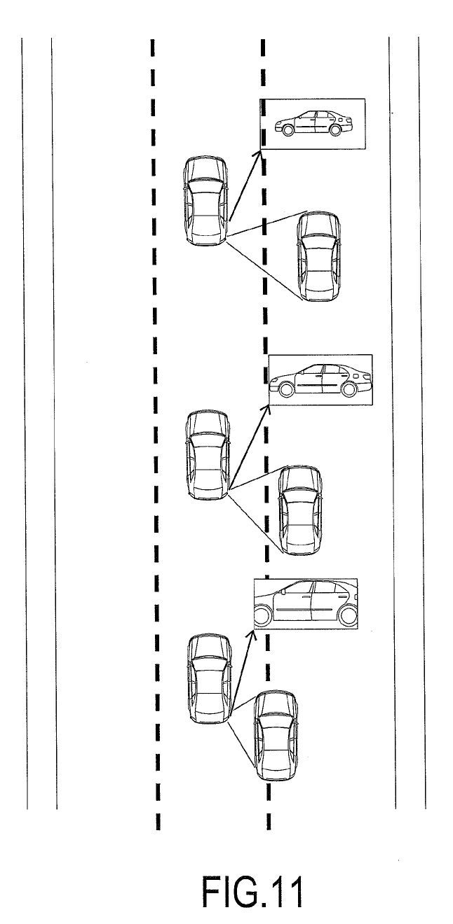

As shown in FIG. 11, after identifying the profiles of other moving vehicles, the projection sizes of them on the video camera 10 can be used to determine whether any of them is suddenly approaching the vehicle. In the schematic plot, the one between the two lane-dividing lines is the vehicle of the driver. The one on the right behind the vehicle is another vehicle driven by another person. The images of the vehicle on the right as seen by the vehicle installed with the disclosed device are indicated by the rectangular frames. As the vehicle behind approaches, the vehicle image captured by the video camera 10 becomes larger.

The method of determining whether any vehicle is approaching can be any of the following. (1) If the profile size of a moving vehicle does not change much within a period (e.g., 2 to 5 minutes) but it suddenly becomes larger at a particular time, then the driver is alerted to check vehicles on both sides. (2) If the profile size of the moving vehicle captured by the video camera 10 exceeds a certain limit, such as one half of the image size, then the driver is alerted to check vehicles on both sides. (3) Using the obtained lane-dividing lines and the region division, it is possible to compute the distance between another moving vehicle and the vehicle. If the distance is lower than a predetermined value, the distance between them is too close and a warning is set off.

In summary, the invention uses several consecutive images to extract a static background of the road. The distances of the vehicle to the lane-dividing lines on both sides can be measured from the images, thereby analyzing whether the vehicle is suddenly deviating from its normal or original path. Moreover, the invention can determine other moving vehicles based upon the static background. If some other moving vehicle suddenly approaches the vehicle or the distance between them is too close, then the invention actively sets off a warning sound to notify the driver. This can provide a safer protection for driving.

What is claimed is:

1. A warning method for deviation of a moving vehicle, comprising the steps of:
continuously capturing images of a road behind the moving vehicle;
analyzing a static background of the road from the captured continuous images, the static background comprising lane-dividing lines on the road;
determining whether the vehicle is deviating by checking a relative position of the moving vehicle with respect to the lane-dividing lines;
outputting a warning signal when the moving vehicle has deviated from its original lane.

2. The warning method for deviation of a vehicle as claimed in claim 1, wherein the static background is divided into multiple regions so that whether the moving vehicle is deviating is determined according to which region the lane-dividing line falls into.

3. The warning method for deviation of a vehicle as claimed in claim 2, wherein the lane-dividing lines and the road surface have distinct gray levels from which the position of the lane-dividing line is determined.

4. The warning method for deviation of a vehicle as claimed in claim 3 further comprising steps of:
determining whether there is any moving object by comparing the captured continuous images with the static background; and
determining whether the moving object is suddenly approaching the moving vehicle by monitoring the motion of the moving object and setting off a warning signal when the moving object is approaching.

5. The warning method for deviation of a vehicle as claimed in claim 4, wherein the step of determining whether the moving object is suddenly approaching the vehicle is done by checking the size of the moving object on the captured continuous images.

6. The warning method for deviation of a vehicle as claimed in claim 4, wherein the step of determining whether the moving object is suddenly approaching the vehicle is done by checking whether the moving object suddenly appears larger in the captured continuous images.

7. The warning method for deviation of a vehicle as claimed in claim 4, wherein the step of determining whether the moving object is suddenly approaching the vehicle is done by checking which region in the static background the moving object falls into and computing the distance between the moving object and the moving vehicle.

8. The warning method for deviation of a vehicle as claimed in claim 5, wherein in the step of continuously capturing images of the road behind the vehicle, the images are captured at a frequency of 20 to 100 frames per second.

9. The warning method for deviation of a vehicle as claimed in claim 6, wherein in the step of continuously capturing images of the road behind the vehicle, the images are captured at a frequency of 20 to 100 frames per second.

10. The warning method for deviation of a vehicle as claimed in claim 7, wherein in the step of continuously capturing images of the road behind the vehicle, the images are captured at a frequency of 20 to 100 frames per second.

11. The warning method for deviation of a vehicle as claimed in claim 3 further comprising:
determining the gear and a speed of the moving vehicle; and
stopping the continuous road images capturing when the moving vehicle is in the neutral gear or the parking gear or the speed is zero.

12. The warning method for deviation of a vehicle as claimed in claim 4 further comprising:
determining the gear and a speed of the moving vehicle; and
stopping the continuous road images capturing when the moving vehicle is in the neutral gear or the parking gear or the speed is zero.

13. The warning method for deviation of a vehicle as claimed in claim 8 further comprising:
determining the gear and a speed of the moving vehicle; and
stopping the continuous road images capturing when the moving vehicle is in the neutral gear or the parking gear or the speed is zero.

14. The warning method for deviation of a vehicle as claimed in claim 9 further comprising:
determining the gear and a speed of the moving vehicle; and
stopping the continuous road image capturing when the moving vehicle is in the neutral gear or the parking gear or the speed is zero.

15. The warning method for deviation of a vehicle as claimed in claim 10 further comprising:
determining the gear and a speed of the moving vehicle; and
stopping the continuous road image capturing when the vehicle is in the neutral gear or the parking gear or the speed is zero.

16. A warning device for deviation of a moving vehicle comprising:
at least one video camera mounted at an appropriate position on the moving vehicle to continuously capture images of a road behind the moving vehicle and generate a video signal;
at least one graphics processor connected to the video camera to receive the video signals from the video camera, the graphic processor analyzing a static background on the road, analyzing whether the moving vehicle is deviating from its original path, and determining whether any surrounding dynamic object is approaching;
a microprocessor connected to the graphics processor and using the determination result of the graphics processor to determine whether to set off a warning to the driver; and
an alarm connected to the microprocessor and controlled by the microprocessor to set off the warning.

17. The warning device for deviation of a moving vehicle as claimed in claim 16 further comprising:
a gear detector connected to the microprocessor to detect gear information of the moving vehicle, wherein the gear information is sent to the microprocessor in real time to determine whether to turn off the graphics processor and the video camera according to the gear information.

18. The warning device for deviation of a moving vehicle as claimed in claim 17 further comprising:
a speed detector connected to the microprocessor to detect a current speed of the vehicle, wherein the current speed is sent to the microprocessor to determine whether to turn off the graphics processor and the video camera.

19. The warning device for deviation of a moving vehicle as in claim 18 comprising two video cameras mounted on both sides in the back of the moving vehicle.

20. The warning device for deviation of a moving vehicle as in claim 18 comprising two graphics processors connected respectively to the two video cameras.
